(19) United States
(12) Patent Application Publication
(10) Pub. No.: US 2024/0281311 A1
(43) Pub. Date: Aug. 22, 2024

(54) QUEUE ADJUSTMENTS TO AVOID MESSAGE UNDERRUN AND USAGE SPIKES

(71) Applicant: Red Hat, Inc., Raleigh, NC (US)

(72) Inventors: Amnon Ilan, Raleigh, NC (US); Michael Tsirkin, Raleigh, NC (US)

(21) Appl. No.: 18/112,253

(22) Filed: Feb. 21, 2023

(51) Int. Cl. G06F 9/54; G06F 9/455

(52) U.S. Cl. CPC G06F 9/546; G06F 9/45558; G06F 2009/45583; G06F 2009/45591

(57) ABSTRACT

Queue adjustments to avoid message underrun and usage spikes are provided by placing a first plurality of messages into sequential slots in a first ring queue; in response to receiving a ring adjustment flag, placing the ring adjustment flag into a next available slot of the sequential slots in the first ring queue; and placing a second plurality of messages received after the first plurality of messages into sequential slots in a second ring queue.

### BACKGROUND

Queues operate on a First-In, First-Out schema in which new elements are added to the “tail” of the queue while the oldest elements are removed from the “head” of the queue. In a ring queue, the queue operates in a fixed space in memory, in which new elements are replace older elements and cycle through available space in the queue. For example, for a ring queue of size n, elements 1-n each populate the next available space in the queue, while element n+1 replaces element 1, element n+2 replaces element 2, element n+3 replaces element 3, etc.

### SUMMARY

The present disclosure provides a new and innovative way to handle queue adjustments to avoid message drop when transferring queues to new spaces in memory. In various computing scenarios that use ring queues (e.g., virtual network devices), sizing the ring appropriately to the workload (and speed of access to the queue) is an important consideration. If the ring is too large, the ring occupies memory that could be used for other tasks; wasting computing resources. However, if the ring is too small, underruns and message loss may occur as new messages overwrite older messages in the ring queue that have not yet been processed. Although a new ring queue can be provided to replace a missized or misconfigured queue as operating and workload conditions change, handover to the new ring can result in double storage of messages during the handover process (wasting computing resources) or memory underruns and packet drops if unprocessed messages remain in the original ring queue, or memory usage to spike, leading to cache misses and slow downs, when the new queue includes messages.

To improve the operation of the computing devices used to handle the ring queues and that process/use the data in the ring queues, the present disclosure provides for a ring transition strategy that avoids directly sending the new queue address directly to the device, but stores the address of the new queue in the initial queue as a flag to be handled by the driver. After the driver reaches the flag in the initial queue, the driver loads the new address for the new queue, and routes new messages to the new queue, thereby ensuring that the new ring queue is populated with messages before the initial queue is exhausted, and without requiring the double-storage of messages while the queues are both active.

In one example, a method is provided that comprises placing a first plurality of messages into sequential slots in a first ring queue; in response to receiving a ring adjustment flag, placing the ring adjustment flag into a next available slot of the sequential slots in the first ring queue; and placing a second plurality of messages received after the first plurality of messages into sequential slots in a second ring queue.

In one example, a system is provided that comprises a processor; and a memory, including instructions that when executed by the processor perform operations including: placing a first plurality of messages into sequential slots in a first ring queue; in response to receiving a ring adjustment flag, placing the ring adjustment flag into a next available slot of the sequential slots in the first ring queue; and placing a second plurality of messages received after the first plurality of messages into sequential slots in a second ring queue.

In one example, a memory device is provided that includes instructions that when executed by a processor perform operations including placing a first plurality of messages into sequential slots in a first ring queue; in response to receiving a ring adjustment flag, placing the ring adjustment flag into a next available slot of the sequential slots in the first ring queue; and placing a second plurality of messages received after the first plurality of messages into sequential slots in a second ring queue.

Additional features and advantages of the disclosed methods, devices, and/or systems are described in, and will be apparent from, the following Detailed Description and the Figures.

### BRIEF DESCRIPTION OF THE FIGURES

FIG. 1 illustrates a high-level component diagram of a computer system, according to examples of the present disclosure

FIG. 2 illustrates an example transition process between a first ring queue to a second ring queue, according to embodiments of the present disclosure.

FIG. 3 illustrates an example multi-stage transition process between a first ring queue, a second ring queue, and a third ring queue, according to embodiments of the present disclosure.

FIG. 4 is a flowchart of an example method of transitioning from an initial ring queue to a new ring queue, according to embodiments of the present disclosure.

FIG. 5 is a flowchart of an example method of assigning messages to ring queues, according to embodiments of the present disclosure.

### DETAILED DESCRIPTION

The present disclosure provides a new and innovative way to handle queue adjustments to avoid message drop when transferring queues to new spaces in memory. In various computing scenarios that use ring queues (e.g., virtual network devices), sizing the ring appropriately to the workload (and speed of access to the queue) is an important consideration. If the ring is too large, the ring occupies memory that could be used for other tasks; wasting computing resources. However, if the ring is too small, underruns and message loss may occur as new messages overwrite older messages in the ring queue that have not yet been processed. Although a new ring queue can be provided to replace a missized or misconfigured queue as operating and workload conditions change, handover to the new ring can result in double storage of messages during the handover process (wasting computing resources) or memory underruns and packet drops if unprocessed messages remain in the original ring queue, or memory usage to spike, leading to cache misses and slow downs, when the new queue includes messages.

To improve the operation of the computing devices used to handle the ring queues and that process/use the data in the ring queues, the present disclosure provides for a ring transition strategy that avoids directly sending the new queue address directly to the device (e.g., to simply device performance), but stores the address of the new queue in the initial queue as a flag to be handled by the driver. After the driver reaches the flag in the initial queue, the driver loads the new address for the new queue, and routes new messages to the new queue, thereby ensuring that the new ring queue is populated with messages before the initial queue is exhausted, and without requiring the double-storage of messages while the queues are both active.

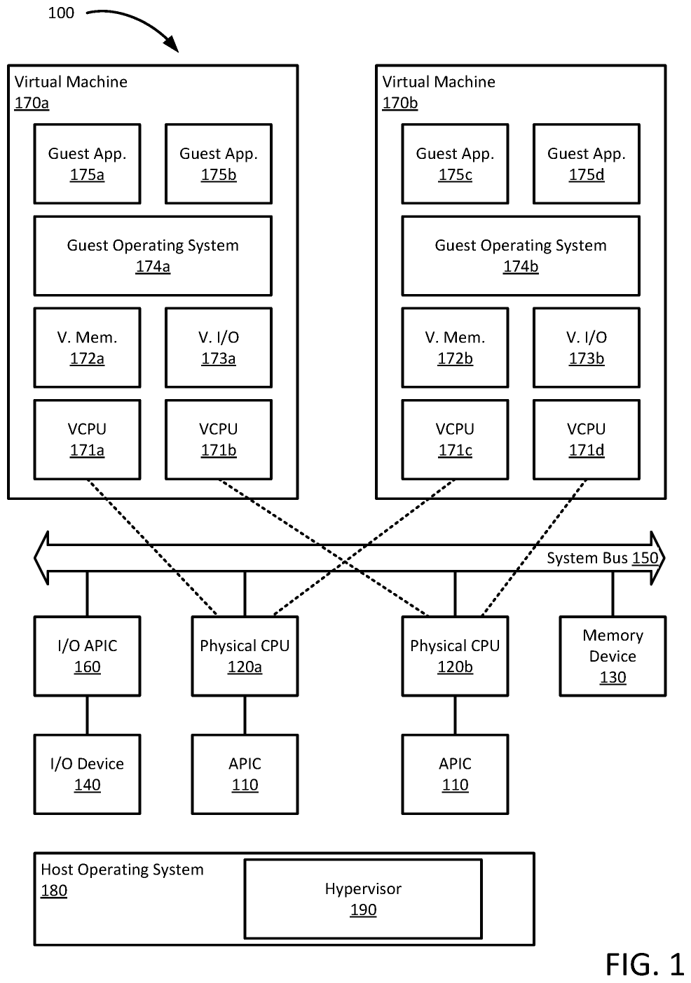

FIG. 1 illustrates a high-level component diagram of a computer system 100, according to examples of the present disclosure. The computer system 100 may include one or more physical central processing units (PCPUs) 120a-b (generally or collectively, processors or PCPUs 120) communicatively coupled to memory devices 130, and input/output (I/O) devices 140 via a system bus 150.

In various examples, the PCPUs 120 may include various devices that are capable of executing instructions encoding arithmetic, logical, or I/O operations. In an illustrative example, a PCPU 120 may follow Von Neumann architectural model and may include an arithmetic logic unit (ALU), a control unit, and a plurality of registers. In another aspect, a PCPU 120 may be a single core processor which is capable of executing one instruction at a time (or process a single pipeline of instructions), or a multi-core processor which may simultaneously execute multiple instructions. In another aspect, a PCPU 120 may be implemented as a single integrated circuit, two or more integrated circuits, or may be a component of a multi-chip module (e.g., in which individual microprocessor dies are included in a single integrated circuit package and hence share a single socket).

In various examples, the memory devices 130 include volatile or non-volatile memory devices, such as RAM, ROM, EEPROM, or any other devices capable of storing data. In various examples, the memory devices 130 may include on-chip memory for one or more of the PCPUs 120.

In various examples, the I/O devices 140 include devices providing an interface between a PCPU 120 and an external device capable of inputting and/or outputting binary data.

The computer system 100 may further comprise one or more Advanced Programmable Interrupt Controllers (APIC), including one local APIC 110 per PCPU 120 and one or more I/O APICs 160. The local APICs 110 may receive interrupts from local sources (including timer interrupts, internal error interrupts, performance monitoring counter interrupts, thermal sensor interrupts, and I/O devices 140 connected to the local interrupt pins of the PCPU 120 either directly or via an external interrupt controller) and externally connected I/O devices 140 (i.e., I/O devices connected to an I/O APIC 160), as well as inter-processor interrupts (IPIs).

In a virtualization environment, the computer system 100 may be a host system that runs one or more virtual machines (VMs) 170a-b (generally or collectively, VM 170), by executing a hypervisor 190, often referred to as “virtual machine manager,” above the hardware and below the VMs 170, as schematically illustrated by FIG. 1. In one illustrative example, the hypervisor 190 may be a component of a host operating system 180 executed by the host computer system 100. Additionally or alternatively, the hypervisor 190 may be provided by an application running under the host operating system 180, or may run directly on the host computer system 100 without an operating system beneath it. The hypervisor 190 may represent the physical layer, including PCPUs 120, memory devices 130, and I/O devices 140, and present this representation to the VMs 170 as virtual devices.

Each VM 170a-b may execute a guest operating system (OS) 174a-b (generally or collectively, guest OS 174) which may use underlying VCPUs 171a-d (generally or collectively, VCPU 171), virtual memory 172a-b (generally or collectively, virtual memory 172), and virtual I/O devices 173a-b (generally or collectively, virtual I/O devices 173). A number of VCPUs 171 from different VMs 170 may be mapped to one PCPU 120 when overcommit is permitted in the virtualization environment. Additionally, each VM 170a-b may run one or more guest applications 175a-d (generally or collectively, guest applications 175) under the associated guest OS 174. The guest operating system 174 and guest applications 175 are collectively referred to herein as “guest software” for the corresponding VM 170.

In certain examples, processor virtualization may be implemented by the hypervisor 190 scheduling time slots on one or more PCPUs 120 for the various VCPUs 171a-d. In an illustrative example, the hypervisor 190 implements the first VCPU 171a as a first processing thread scheduled to run on the first PCPU 120a, and implements the second VCPU 171b as a second processing thread scheduled to run on the first PCPU 120a and the second PCPU 120b.

Device virtualization may be implemented by intercepting virtual machine memory read/write and/or input/output (I/O) operations with respect to certain memory and/or I/O port ranges, and by routing hardware interrupts to a VM 170 associated with the corresponding virtual device. Memory virtualization may be implemented by a paging mechanism allocating the host RAM to virtual machine memory pages and swapping the memory pages to a backing storage when necessary.

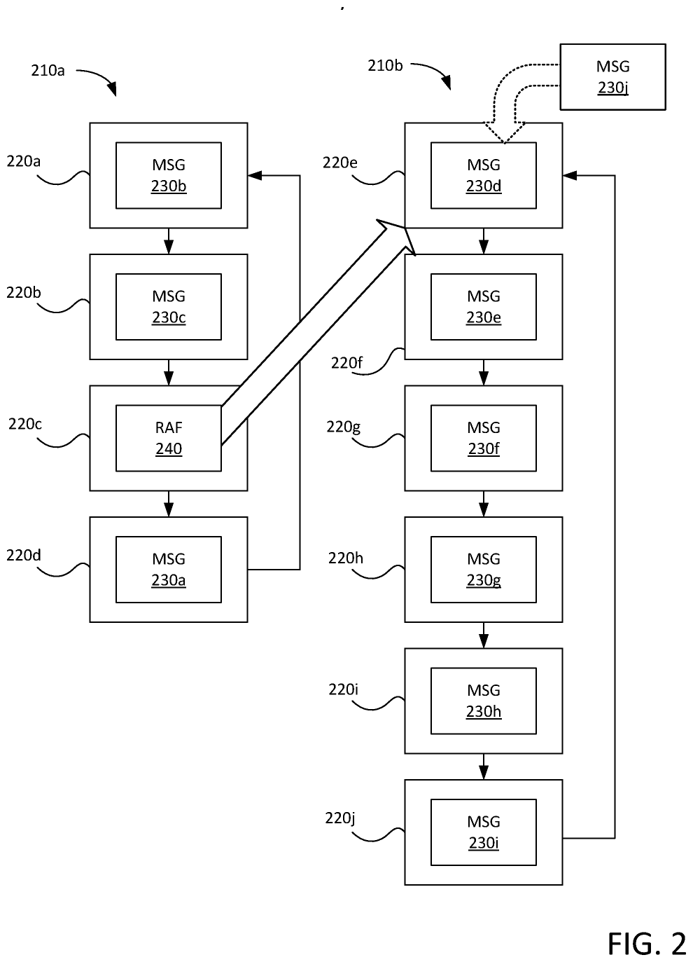

FIG. 2 illustrates an example transition process between a first ring queue 210a (generally or collectively, ring queue 210) to a second ring queue 210b, according to embodiments of the present disclosure. As illustrated, the first ring queue 210a is shown with four slots 220a-d (generally or collectively, slot 220) in which to store messages 230a-c (generally or collectively, messages 230) and ring adjustment flags 240. Similarly, the second ring queue 210b is shown with six slots 220e-j in which to store messages 230 (e.g., messages 230d-j).

In various embodiments, the slots 220 may define a specified number of bytes in memory or may represent a division of the allocated memory for a given ring queue 210 into which a message 230 or ring adjustment flag 240 may be inserted. Similarly, the messages 230 and ring adjustment flags 240 may be a constant number of bits, or may vary in size. The messages 220 may be formatted according to various standards, and may be pre-processed by a driver before being used by or accessed by a user or other device. For example, the driver may verify a checksum in the message 230 to determine whether the message 230 has successfully been received, apply (or remove) encryption, change format or encapsulated/de-encapsulate the message 230, or the like, which may be specified for each message 230 in the given ring queue 210. In some embodiments, the ring adjustment flag 240 includes the address(es) for the new ring queue 210, the size of the new ring queue 210

For example, when used in a virtual network device in a virtualized environment for use by a VM, a ring queue 210 may be used for handling incoming packets. The VM may specify an address in memory for the “head” of the ring queue 210 (e.g., the next available slot 220 in a memory range designated for use as a ring queue 210), and the hypervisor or a driver stores incoming packets at the specified address. In a ring queue 210, the head of the ring queue 210 may be indicated via a head pointer, which identifies the next available slot 220 in the memory to use. As the ring queue 210 occupies a contiguous block of memory addresses, once the head pointer reaches the last slot 220 in a set of sequential slots (e.g., the fourth slot 220d in the first ring queue 210a, the sixth (tenth overall) slot 220j in the second ring queue 210b), the head pointer updates to point to the first slot 220 in the ring queue 210 (e.g., the first slot 220a in the first ring queue 210a, the first (fifth overall) slot 220e in the second ring queue 210b) to define a “ring” or looping pattern of message assignment to memory addresses.

Accordingly, the ring adjustment flag 240, when reached, interrupts the typical looping pattern of a ring queue 210, and directs the driver to read the next message from the new ring queue 210 instead of the current ring queue 210, which has (potentially) been populated with new messages 230. These messages 230 are not held in duplicate in the initial ring queue 210, and once the driver reaches the ring adjustment flag 240, all of the messages 230 in the initial ring queue 210 have been read, and the memory used for the slots 220 can be reallocated for a new purpose without losing unprocessed data. As shown in FIG. 2, after reading the third message 230 in the second slot 220b, the driver reads the ring adjustment flag 240 in the third slot 220c, and proceeds to the fifth slot 220e in the second ring queue 210b to read the fourth message 230d. Once transitioned to the new ring queue 210, the driver resumes the looping pattern in the new ring queue 210 (until interrupted by a subsequent ring adjustment flag 240). As shown in FIG. 2, the second ring queue 210b is populated with the fifth through ninth messages 230d-i in the sequential slots 220e-j, and when a tenth message 230j is received, the tenth message 230j is placed in the fifth slot 220e to replace the fourth message 230d.

The driver can insert a ring adjustment flag 240 into the current ring queue 210 when the driver determines (or is signaled by the VM or hypervisor) that the current ring queue 210 is no longer appropriate for the processing needs of the VM. The driver may determine to insert a ring adjustment flag 240 in response to changes in workload of the VM (e.g., requesting a larger or smaller size ring queue 210 than the current ring queue 210), changes in pre-processing operations to be performed on new messages 230 in the ring queue 210 (e.g., adding or removing processing operations of sender filtering, checksum validation, reformatting, encapsulation, de-capsulation, encryption, decryption, etc.), a defragmentation or other memory allocation request (e.g., to move the ring queue 210 to a new location in a register or a new register to allow for more efficient memory allocation or leaving less memory space as “padding” or otherwise unusable), or the like. Additionally, once a ring adjustment flag 240 is read from a given ring queue 210, the driver knows that the device has been provided with all of the messages 230 stored in the ring queue 210, and the memory addresses of the ring queue 210 can be deallocated or otherwise assigned for other uses.

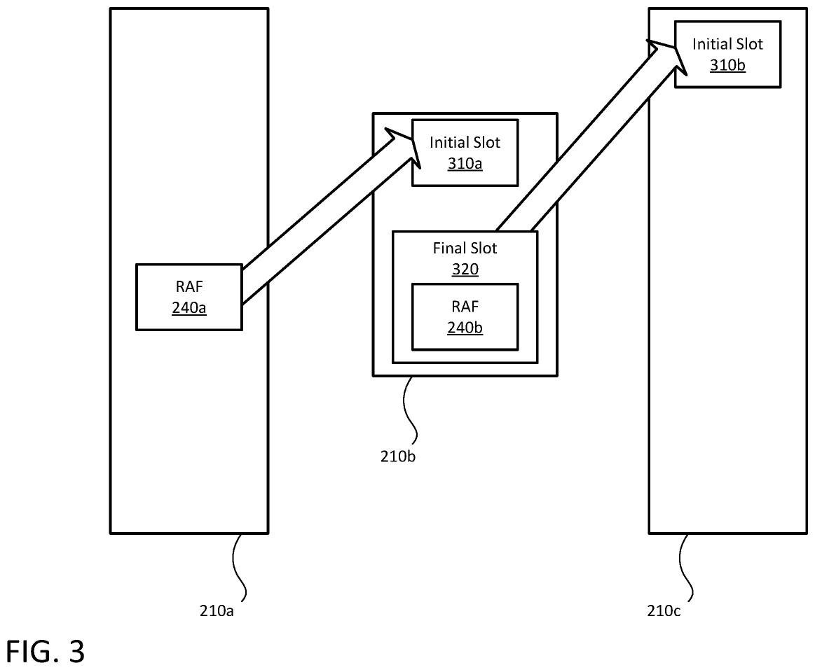

FIG. 3 illustrates an example multi-stage transition process between a first ring queue 210a, a second ring queue 210b, and a third ring queue 210c, according to embodiments of the present disclosure. In various embodiments, one VM or device may be associated with two or more ring queue 210 at the same time due to the driver identifying a new condition to that warrants inserting a ring adjustment flag 240 before the contents of an earlier ring queue have been processed up to an earlier ring adjustment flag 240.

In some embodiments, the driver may insert a ring adjustment flag 240 in response to a queue overflow threshold being reached, indicating that the ring queue 210 is being filled at a faster rate than an associated device is reading from the ring queue 210 and that the head is within a threshold number of slots 220 from an un-read message 230 in the ring queue 210. As the conditions leading to the queue overflow may be temporary (e.g., due to a spike in demand, a hypervisor not scheduling a VM for a given period of time), the driver may determine that the ring queue 210 does not need to be resized, but merely temporarily augmented to handle the spike in inputs entering the queue or the dip in the ability of the device to read from the queue. Accordingly, the driver may insert a first ring adjustment flag 240a in a next available slot 220 in a first ring queue 210a, and request a second ring queue 210b for use for temporary overflow and a third ring queue 210c to resume normal operations with.

When used for temporary overflow, the second ring queue 210b may be smaller in size (e.g., taking up less memory) or larger than (e.g., taking up more memory) than the first ring queue 210a, while the third ring queue 210c (for resuming normal operations) is the same size (e.g., taking up the same space in memory) as the first queue 210a. In various embodiments, the size of the second ring queue 210b may vary based on the observed spike in demand or dip in processing ability to handle a predicted amount of overflow from the initial ring queue 210. When the second ring queue 210b is requested for temporary overflow in addition to a third ring queue 210c for return to normal operations, the first ring adjustment flag 240a may include or point to the address of the initial slot 310a in the second ring queue 210b, which the driver may preload with a second ring adjustment flag 240b in the final slot 320 of the second ring queue 210b, which points to the initial slot 310b of the third ring queue 210c. Although discussed as a ring queue 210, the overflow queue may be a fixed size queue that does not exhibit a looping pattern, as new messages 230 are placed into the third ring queue 210c once the head pointer reaches the final slot 320 of the second ring queue 210b.

Accordingly, the driver can provide a ring queue 210 that is sized to handle typical operations and temporarily increase the size of the queue to handle abnormal operations or provide an overflow queue without the risk of data overruns or dropped messages 230, thereby saving memory space in the computing environment and improving the functionality of the underlying devices.

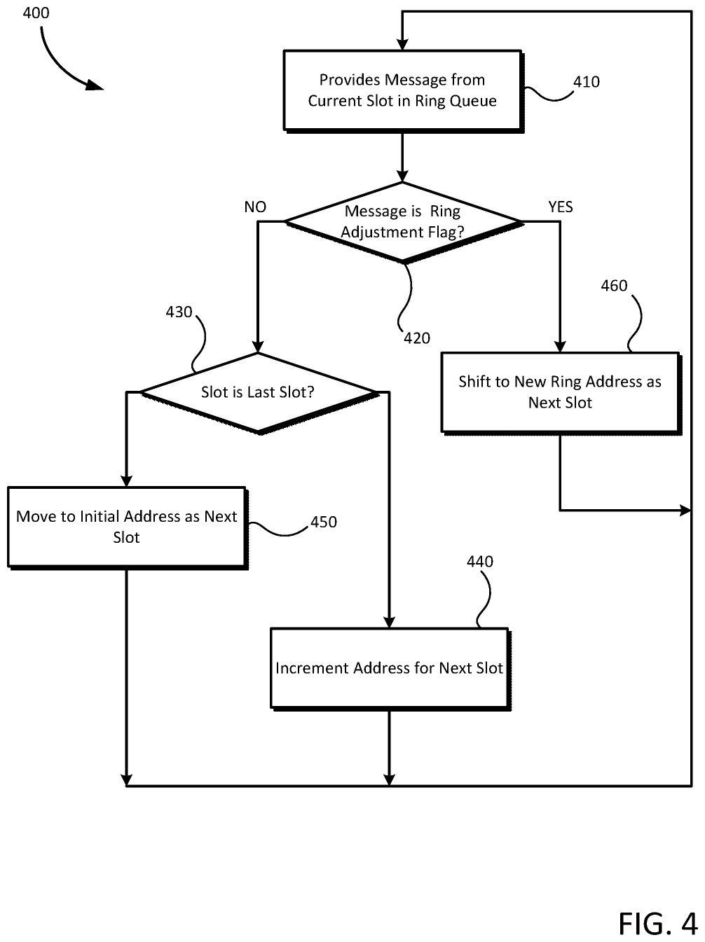

FIG. 4 is a flowchart of an example method 400 of transitioning from an initial ring queue 210 to a new ring queue 210, according to embodiments of the present disclosure. Method 400 begins at block 410 where a driver provides a message 230 from the current slot 220 in a ring queue 210 to a device to process.

At block 420, the driver determines whether the message 230 provided in block 410 was a ring adjustment flag 240. When the message 230 was not a ring adjustment flag 240, method 400 proceeds to block 430. When the message 230 was a ring adjustment flag 240, method 400 proceeds to block 460, where the driver updates the head pointer to point to the first slot 220 in the sequence of slots 220 in the next ring queue 210. Once the ring adjustment flag 210 is read from the initial ring queue 210, the driver may then deallocate the memory addresses for that ring queue 210, thereby freeing those memory addresses for other uses without losing data for the device associated with that (now-deallocated) ring queue 210.

At block 430, the driver determines whether the slot 220 from which the message 230 provided to the device in block 410 was the last slot in the ring queue 210. When the slot 220 was not the last slot, method 400 proceeds to block 440, where the driver updates the head pointer to point to the next slot 220 in the sequence of slots 220 in the current ring queue 210. When the slot 220 was the last slot, method 400 proceeds to block 450, where the driver updates the head pointer to point to the first slot 220 in the sequence of slots 220 in the current ring queue 210.

After block 440, block 450, or block 460 is performed, method 400 returns to block 410 for the driver to provide the next message 230 from the pointed-to slot 220 to the device. Method 400 may thus continue until terminated.

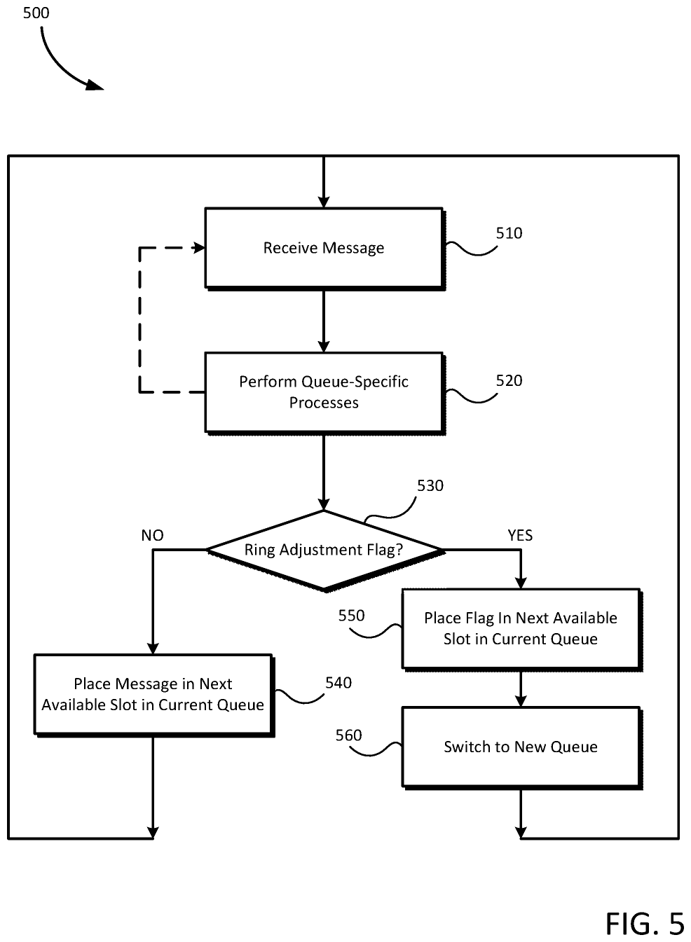

FIG. 5 is a flowchart of an example method 500 of assigning messages 230 and ring adjustment flags 240 to ring queues 210, according to embodiments of the present disclosure. Method 500 begins at block 510 where the driver receives a message 230, such as a packet from an external device.

At block 520, the driver performs various queue-specific processes on the received message 230. In various embodiments, according to the settings of the current ring queue 210, the driver may be assigned to reject messages 230 from certain sources (e.g., filtering messages 230), perform checksum validation, encryption, decryption, re-formatting, encapsulation, de-capsulation, or other operations of the message 230 before the message 230 can be provided to the device/VM. In various embodiments, the queue-specific processes may include rejecting the message 230 or requesting the message 230 to be re-sent, and method 500 may then return to block 510 to receive the next message 230.

At block 530, the driver determines whether the received message 230 is a ring adjustment flag 240 or a command for the driver to generate a ring adjustment flag 240. When the received message 230 is a ring adjustment flag 240 (or a command to generate a ring adjustment flag 240), method 500 proceeds to block 550. Otherwise, method 500 proceeds to block 540.

At block 540, the driver places the message 230 in the next available slot in the current ring queue 210, which may be the first slot 220 if the last filled slot 220 was the last slot 220 in the ring queue 210. Method 500 may then return to block 510 to receive the next message 230.

At block 550, the driver places a ring adjustment flag 240 in the next available slot in the current ring queue 210, which may be the first slot 220 if the last filled slot 220 was the last slot 220 in the ring queue 210.

At block 560, the driver switches to the new ring queue 210 to place the next message 230 (and any subsequent messages 230). Accordingly, when method 500 returns to block 510 from block 560 to receive the next message 230, the driver will place the message 230 into a different ring queue 210 than the ring queue 210 in which the ring adjustment flag 240 was placed in the last performance of block 550.

Method 500 may thus continue until terminated.

Programming modules, may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable user electronics, minicomputers, mainframe computers, and the like. Embodiments may also be practiced in distributed computing environments where tasks are performed by remote processing devices that are linked through a communications network. In a distributed computing environment, programming modules may be located in both local and remote memory storage devices.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

To the extent that any of these aspects are mutually exclusive, it should be understood that such mutual exclusivity shall not limit in any way the combination of such aspects with any other aspect whether or not such aspect is explicitly recited. Any of these aspects may be claimed, without limitation, as a system, method, apparatus, device, medium, etc.

It should be understood that various changes and modifications to the examples described herein will be apparent to those skilled in the relevant art. Such changes and modifications can be made without departing from the spirit and scope of the present subject matter and without diminishing its intended advantages. It is therefore intended that such changes and modifications be covered by the appended claims.

What is claimed is:

1. A method, comprising:
placing a first plurality of messages into sequential slots in a first ring queue;
in response to receiving a ring adjustment flag, placing the ring adjustment flag into a next available slot of the sequential slots in the first ring queue; and
placing a second plurality of messages received after the first plurality of messages into sequential slots in a second ring queue.

2. The method of claim 1, wherein the second ring queue includes a different number of sequential slots in a memory than the first ring queue.

3. The method of claim 1, wherein the second ring queue includes a different processing operation for reading messages that the first ring queue.

4. The method of claim 1, wherein the second ring queue is stored in a different register of a memory than the first ring queue.

5. The method of claim 1, further comprising:
in response to a device reading the ring adjustment flag, deallocating memory assigned to the first ring queue.

6. The method of claim 1, further comprising:
in response to receiving a second ring adjustment flag before the ring adjustment flag is read by a device, placing a second ring adjustment flag into a next available slot of the sequential slots in the second ring queue; and
placing a third plurality of messages received after the second plurality of messages into sequential slots in a third ring queue.

7. The method of claim 1, wherein the ring adjustment flag is received in response to a queue overflow threshold being reached, further comprising:
placing a second ring adjustment flag into a final available slot of the sequential slots in the second ring queue, wherein the second ring queue is of a smaller size than the first ring queue; and
placing a third plurality of messages received after the first plurality of messages into sequential slots in a third ring queue of an equal size as the first ring queue.

8. A system, comprising:
a processor; and
a memory, including instructions that when executed by the processor perform operations including:
placing a first plurality of messages into sequential slots in a first ring queue;
in response to receiving a ring adjustment flag, placing the ring adjustment flag into a next available slot of the sequential slots in the first ring queue; and
placing a second plurality of messages received after the first plurality of messages into sequential slots in a second ring queue.

9. The system of claim 8, wherein the second ring queue includes a different number of sequential slots in a memory than the first ring queue.

10. The system of claim 8, wherein the second ring queue includes a different processing operation for reading messages that the first ring queue.

11. The system of claim 8, wherein the second ring queue is stored in a different register of a memory than the first ring queue.

12. The system of claim 8, the operations further comprising:
in response to a device reading the ring adjustment flag, deallocating memory assigned to the first ring queue.

13. The system of claim 8, the operations further comprising:
in response to receiving a second ring adjustment flag before the ring adjustment flag is read by a device, placing a second ring adjustment flag into a next available slot of the sequential slots in the second ring queue; and
placing a third plurality of messages received after the second plurality of messages into sequential slots in a third ring queue.

14. The system of claim 8, wherein the ring adjustment flag is received in response to a queue overflow threshold being reached, further comprising:
placing a second ring adjustment flag into a final available slot of the sequential slots in the second ring queue, wherein the second ring queue is of a smaller size than the first ring queue; and
placing a third plurality of messages received after the first plurality of messages into sequential slots in a third ring queue of an equal size as the first ring queue.

15. A memory device that includes instructions that when executed by a processor perform operations comprising:
placing a first plurality of messages into sequential slots in a first ring queue;
in response to receiving a ring adjustment flag, placing the ring adjustment flag into a next available slot of the sequential slots in the first ring queue; and
placing a second plurality of messages received after the first plurality of messages into sequential slots in a second ring queue.

16. The memory device of claim 15, wherein the second ring queue includes a different number of sequential slots in a memory than the first ring queue.

17. The memory device of claim 15, wherein the second ring queue includes a different processing operation for reading messages that the first ring queue.

18. The memory device of claim 15, wherein the second ring queue is stored in a different register of a memory than the first ring queue.

19. The memory device of claim 15, the operations further comprising:
in response to a device reading the ring adjustment flag, deallocating memory assigned to the first ring queue.

20. The memory device of claim 15, further comprising:
in response to receiving a second ring adjustment flag before the ring adjustment flag is read by a device, placing a second ring adjustment flag into a next available slot of the sequential slots in the second ring queue; and
placing a third plurality of messages received after the second plurality of messages into sequential slots in a third ring queue.
